(19) United States
(12) Patent Application Publication
(10) Pub. No.: US 2024/0002684 A1
(43) Pub. Date: Jan. 4, 2024

(54) METHOD OF TRANSFERRING PARTICLES TO A COATING SURFACE

(71) Applicant: 3M INNOVATIVE PROPERTIES COMPANY, St. Paul, MN (US)

(72) Inventors: Benjamin R. Coonce, South St. Paul, MN (US); Morgan A. Priolo, Woodbury, MN (US); Uma Rames Krishna Lagudu, Lake Elmo, MN (US)

(21) Appl. No.: 18/039,875

(22) PCT Filed: Nov. 29, 2021
(86) PCT No.: PCT/IB2021/061082

§ 371 Date: Jun. 1, 2023

Related U.S. Application Data
(60) Provisional application No. 63/121,675, filed on Dec. 4, 2020.

(51) Int. Cl. C09D 7/80; C09D 4/00; C09D 7/40; C09D 7/61; C08F 122/10; C08F 122/20; C09D 135/02

(52) U.S. Cl. CPC C09D 7/80; C09D 4/00; C09D 7/67; C09D 7/61; C08F 122/1006; C08F 122/20; C09D 135/02

(57) ABSTRACT

Methods of embedding particles (e.g., nanoparticles) in a coating, the methods including contacting a first surface of a particle layer with a curable resin, followed by curing the curable resin to form a coating having a first coating surface and an opposing second coating surface, resulting in the particles being concentrated at the first coating surface. Also provided are applications for materials prepared according to the disclosed methods in, for example, hardcoating and nano-replication via reactive ion etching.

### TECHNICAL FIELD

The present disclosure generally relates to methods of transferring particles to a coating surface, especially methods of transferring a layer of nanoparticles to a coating surface.

### BACKGROUND

A hardcoat can be useful as a protective layer on a substrate, particularly when the substrate may be exposed to physical wear and/or extreme weather conditions. For example, hardcoats have been used to protect the face of optical displays. Such hardcoats typically contain inorganic oxide particles, e.g., silica, of nanometer dimensions dispersed in a binder precursor resin matrix, and are described, for example, in U.S. Pat. No. 9,377,563 (Hao et al.).

### SUMMARY

Hardcoats prepared according to the present disclosure may beneficially employ reduced total amounts of nano-silica filler required in the formulation by forcing the filler to concentrate at the coating surface where it may be most effective at retarding abrasion. This reduced level of nano-silica in the hardcoat may also have a positive impact on the resistance to outdoor weathering of the product.

In one aspect, provided are methods of embedding particles (e.g., nanoparticles) in a coating, the methods including contacting a first surface of a particle layer with a curable resin, followed by curing the curable resin to form a coating having a first coating surface and an opposing second coating surface, resulting in the particles being concentrated at the first coating surface.

In another aspect, provided are applications for materials prepared according to the disclosed methods in, for example, hardcoating and nano-replication via reactive ion etching.

As used herein:

The terms “cure” and “curing” refer to processes through which a material hardens and/or becomes solid. Curing can include processes such as, for example, polymerization, crosslinking, drying, cooling from melt, electrolyte complexation, and combinations thereof.

The term “monolayer” refers to a layer of particles, e.g., nanoparticles, that is one particle thick. The term “continuous layer” refers to a layer that is substantially free from openings. The term “(meth)acrylate” refers to an acrylate, a methacrylate, or both. The term “precursor” refers to a constituent part or reactant which, when reacted, cured, and/or polymerized will form a hardened material. A precursor may include a monomer and/or an oligomer.

The term “alkyl” refers to a monovalent group which is a saturated hydrocarbon. The alkyl can be linear, branched, cyclic, or combinations thereof and typically has 1 to 30 carbon atoms. In some embodiments, the alkyl group contains 1 to 30, 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and 2-ethythexyl.

Features and advantages of the present disclosure will be further understood upon consideration of the detailed description as well as the appended claims

### BRIEF DESCRIPTION OF THE DRAWINGS

FIG. 1 is a cross-sectional view of a laminate including a coating prepared according to some embodiments of the present disclosure.

FIG. 2 is a schematic representation of an apparatus for transferring nanoparticles to a coating surface according to some embodiments of the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

To achieve a desired abrasion resistance effect, hardcoat formulations can commonly include up to 40 wt. % of a filler, such as, for example, nano-silica particles. However, an abundance of filler particles in the hardcoat bulk may be undesirable in some circumstances. For example, hardcoats including an abundance of filler particles throughout the hardcoat bulk, particularly when used outdoors, tend to suffer embrittlement and hazing issues, i.e., weathering, due to the amount of nano-silica present in the hardcoat resin formulations. By constructing the hardcoat according to the present disclosure, the total amount of nano-silica filler required in the formulation can be reduced by forcing the filler to concentrate at the coating surface where it may be most effective at retarding abrasion. This reduced level of nano-silica in the hardcoat may also have a positive impact on the resistance to outdoor weathering of the product.

It has been observed that positively-charged nano-silica particles readily deposit onto the surface of a silicon wafer and that such nanoparticles may subsequently be cleaned from the silicon wafer surface with a strippable coating. Details regarding this cleaning process are disclosed in U.S. patent application Ser. No. 63/121,696, entitled “LAMINATES FOR CLEANING SUBSTRATE SURFACES AND METHODS OF USE THEREOF,” which is filed on the same day as the present disclosure. Upon transfer to the strippable coating, it has been observed that the nanoparticles concentrate at a surface of the strippable coating.

Provided herein are methods of preparing a product film having a coating with a uniform layer of nanoparticles concentrated at the coating surface. This construction can be employed in several meaningful applications, such as, for example in the field of hardcoats, where abrasion and scratch resistance are important characteristics for protection of underlying substrates, as well as applications in the field of nano-replication via reactive ion etching. The disclosed methods are highly customizable as the substrate (e.g., oxide surface), carrier film, coating formulation, and nanoparticles can all be independently tailored to meet desired performance requirements.

In one aspect, a method of embedding nanoparticles in a coating is provided, the method comprising the steps of contacting a first surface of a nanoparticle layer with a curable resin, and curing the curable resin to form a coating having a first coating surface and an opposing second coating surface, where the nanoparticles are concentrated at the first coating surface.

### Nanoparticle Layer

The nanoparticle layer may include particles comprising, for example, silica, alumina, ceria, diamond, titanium dioxide, zinc oxide, tungsten oxide, zirconia, and combinations thereof. In some embodiments, the particles of the nanoparticle layer may be of a uniform size and shape such as, for example, a spherical shape having an average diameter of 1 nm to 100 nm (e.g., 20 nm). In some embodiments, the particles of the nanoparticle layer may be of an irregular shape or a mixture of regular and/or irregular shapes.

In some preferred embodiments, the nanoparticle layer is coated on a substrate by methods known to those of ordinary skill in the relevant arts before it is contacted with the curable resin. In some embodiments, the nanoparticle layer is a monolayer. In some embodiments, the monolayer is a continuous layer. The substrate onto which the nanoparticle layer may be coated is typically of a rigid construction that preferentially adsorbs the nanoparticles, either by charge or other interaction. The substrate may comprise a variety of known materials, such as, for example, a silicon (e.g., a silicon wafer), a glass, a metal, a metal oxide, a polymeric film, and combinations thereof.

### Curable Resin

The composition of the curable resin is not particularly limited. The curable resin is capable of being cured and the curing technique is not particularly limited and may include, for example, curing by actinic radiation, thermal curing, e-beam curing and combinations thereof. Actinic radiation may include electromagnetic radiation in the UV, e.g. 100 to 400 nm, and visible range, e.g. 400 to 700 nm, of the electromagnetic radiation spectrum. Due to its rapid cure characteristics, the curing of the curable resin by actinic radiation may be preferred. The curable resin may include monomers, oligomers and/or polymers that can be cured by conventional free-radical mechanisms.

In some embodiments, the curable resin includes one or more (meth)acrylates. The (meth)acrylate may be at least one of monomeric, oligomeric and polymeric. The (meth)acrylate may be polar, non-polar or mixtures thereof. Non-polar (meth)acrylate may include alkyl meth(acrylate). Useful non-polar (meth)acrylate include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, tort-butyl (meth)acrylate, n-pentyl (meth)acrylate, iso-pentyl (meth)acrylate (i.e., iso-amyl (meth)acrylate), 3-pentyl (meth)acrylate, 2-methyl-1-butyl (meth)acrylate, 3-methyl-I -butyl (meth)acrylate, stearyl (meth)acrylate, phenyl (meth)acrylate, n-hexyl (meth)acrylate, iso-hexyl (meth)acrylate, cyclohexyl (meth)acrylate, 2-methyl-1-pentyl (meth)acrylate, 3-methyl-1-pentyl (meth)acrylate, 4-methyl-2-pentyl (meth)acrylate, 2-ethyl-1-butyl (meth)acrylate, 2-methy-1-hexyl (meth)acrylate, (meth)acrylate, cyclohexyl (meth)acrylate, 3-heptyl (meth)acrylate, benzyl (meth)acrylate, (meth)acrylate, iso-octyl (meth)acrylate, 2-octyl (meth)acrylate, 2-ethyl-1-hexyl (meth)acrylate, n-decyl (meth)acrylate, iso-decyl (meth)acrylate, isobornyl(meth)actylate, 2-propylheptyl (meth)acrylate, isononyl (meth)acrylate, isophoryl (meth)acrylate, n-dodecyl (meth)acrylate (i.e., lauryl(meth)acrylate), n-tridecyl (meth)acrylate, iso-tridecyl (meth)acrylate, 3,7-dimethyl-octyl (meth)acrylate, and any combinations or mixtures thereof. Combinations of non-polar (meth)acrylates may be used.

Polar (meth)acrylates include, but ate not limited to, 2-hydroxyethyl (meth)acrylate; poly(alkoNyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyetliyl methacrylate; alkoxylated (meth)acrylates (e.g. ethoxylated and propoxylated (meth)acrylate), and mixtures thereof. The alkoxylated (meth)acrylates may he monofunctional difunctional, trifunctional or have higher functionality. Ethoxylated acrylates include, but are not limited to, ethoxy hued (3) trimethylolpropane triacrylate (available under the trade designation “SR454”, from Sartomer, Exton, Pennsylvania), ethoxylated (6) trimethylolproparie triacrylate (available under the trade designation “SR499”, from Sartomer), ethoxylated (6) trimethylolpropane triacrylate (available under the trade designation “MIRAMER M3160” from Miwon North America Inc., Exton Pennsylvania), ethoxylated. (9) trimethylolpropane triacrylatc (available under the trade designation “SR502”, from Summer), ethoxylated (15) trimethylolpropanc triacrylate (available under the trade designation “SR9035”, from Sartomer), ethoxylated (20) trimethylolpropane triacrylate (available under the trade designation “SR415”, from Sartomer), polyethylene glycol (600) diacrylate (available under the trade designation “SR610”, from Sartomer), polyethylene glycol (400) diacrylate (available under the trade designation “SR344”, from Sartomer), polyethylene glycol (200) diacrylate (available under the trade designation “SR259”, from Sartomer), ethoxylated (3) bisphenol A diacrylate (available under the trade designation “SR349”, from Sartomer), ethoxylated (4) bisphenol A diacrylate (available under the trade designation “SR601”, from Sartomer), ethoxylated (10) bisphenol A diaclylate (available under the trade designation “SR602”, from Sartomer), ethoxylated (30) bisphenol A diaclylate (available under the trade designation “SR9038”, from Sartomer), propoxylated neopentyl glycol diacrylate (available under the trade designation “SR9003”, from Sartomer), polyethylene glycol dimethacrylate (available under the trade designation “SR210A”, from Sattomer), polyethylene glycol (600) dimethacrylate (available under the trade designation “SR252”, from Sartomer), polyethylene glycol (400) dimetliacrylate (available under the trade designation “SR603”, from Sartomer), ethoxylated (30) bisphenol A dimetloctylate (available under the trade designation “SR9036”, from Sartomer. Combinations of polar (meth)acrylates may be used.

Other monomers that may be used and considered to be in the categoty of polar (meth)acrylates include N-vinylpytiolidone; N-vinylcaprolaetain; acrylamides; mono- or di-N-alkyl substituted acrylamide; t-butyl acrylamide; dimethylarninoethyl acrylamide; N-octyl acrylamide and; acrylic acid, and methacrylic acid, and alkyl vinyl ethers, including vinyl methyl ether.

In some embodiments, the curable resin includes a precursor, such as, for example a polyurethane precursor, an epoxy precursor (typically an epoxide and hardener), a polyurea precursor, or combinations thereof.

In some embodiments, the curable resin includes a crosslinker. The crosslinker often increases the cohesive strength and the tensile strength of the cured adhesive layer. The crosslinker can have at least two functional groups, e.g., two ethylenically unsaturated groups, which are capable of polymerizing with other components of the curable resin. Suitable crosslinkers may have multiple (meth)acryloyl groups. Alternatively, the crosslinker can have at least two groups that are capable of reacting with various functional groups (i.e., functional groups that are not ethylenically unsaturated groups) on another monomer. For example, the crosslinker can have multiple groups that can react with functional groups such as acidic groups on other monomers.

Crosslinkers with multiple (meth)acryloyl groups can be di(meth)acrylates, tri(meth)acrylates, tetra(meth)acrylates, penta(meth)acrylates, and the like. In many aspects, the crosslinkers contain at least two (meth)acryloyl groups. Exemplary crosslinkers with two acryloyl groups include, but are not limited to, 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene,/polypropylene copolymer diacrylate, polybutadiene di(meth)acrylate, propoxylated glycerin tri(meth)acrylate, and neopentyl glycol hydroxypivalate diacrylate modified caprolactone.

Exemplary crosslinkers with three or four (meth)acryloyl groups include, but are not limited to, trimethylolpropane triaclate (available under the trade designation “TMPTA-N” from Cytec Industries, Inc., Smyrna, Ga. and under the trade designation “SR351” from Sartomer), pentaerythritol triacrylate (available under the trade designation “SR444” from Sartomer), tris(2-hydroxyethylisocyanurate) triaciylate (available under the trade designation “SR368” from Sartomer), a mixture of pentaerythritol triaciylate and pentaerythritol tetraacrylate (available under the trade designation “PETIA” with an approximately 1:1 ratio of tetraacrylate to triacry late and under the trade designation “PETA-K” with an approximately 3:1 ratio of tetraacrylate to triactylate, from Cytec Industries, Inc.), pentaerythritol tetraacrylate (available under the trade designation “SR295” from Sartomer“), di-trimethylolpropane tetraacrylate (available under the trade designation “SR355” from Sartomer), and ethoxylated pentaerythritol tetraacrylate (available under the trade designation “SR494” from Sartomer). An exemplary crosslinker with five (meth)acryloyl groups includes, but is not limited to, dipentaerythritol pentaacrylate (available under the trade designation “SR399” front Sartomer). Previously mentioned multifunctional polar (meth)acrylate may be considered crosslinkers.

In some aspects, the crosslinkers are polymeric materials that contain at least two Onethiacryloyi groups. For example, the crosslinkers can be poly(alkylene oxides) with at least two acryloyl groups (polyethylene glycol diacrylates commercially available from Sartomer under the trade designation “SR210”, “SR252”, and “SR603”, for example). The crosslinkers poly(urethmes) with at least two (meth)acryloyl groups (polyurethane diacrylates such as CN9018 from Sartomer). As the higher molecular weight of the crosslinkers increases, the resulting acrylic copolymer tends to have a higher elongation before breaking. Polymeric crosslinkers tend to be used in greater weight percent amounts compared to their non-polymeric counterparts.

Other types of crosslinkers can be used rather than those having at least two (meth)acryloyl groups. The crosslinker can have multiple groups that react with functional groups such as acidic groups on other monomers. For example, monomers with multiple aziridinyl groups can be used that are reactive with carboxyl groups. For example, the crosslinkers can be a his-amide crosslinker as described in U.S. Pat. No. 6,777,079 (Zhou et al.).

The amount of crosslinker in the curable resin is not particularly limited and depends on the desired final properties of the cured adhesive layer formed therefrom. Crosslinking may improve the cohesive strength of the cured adhesive layer and facilitate removal from the surface of the substrate without leaving residue while improving the ability of the cured adhesive layer to entrap the particulate contaminant and remove it from the substrate surface. In some embodiments the curable resin may include at least 5 percent, at least 10 percent, at least :30 percent, at least 40 percent, at least 50 percent, at least 60 percent at least 70 percent, at least 80 percent, at least 90 percent, at least 95 percent or at least 97 percent by weight of crosslinker. In some embodiments the curable resin may include at least 5 percent at least 10 percent, at least 20 percent, at least 30 percent and/or less than 100 percent, less than 99 percent, less than 97 percent, less than 95 percent, less than 90 percent, less than 85 percent by weight of crosslinker. In some embodiments the curable resin may include from between 50 and 100 percent, between 60 and 100 percent, between 70 and 100 percent, between 80 and 100 percent, between 90 and 100 percent, between and 98 percent, between 60 and 98 percent, between 70 and 98 percent, between 80 and 98 percent, between 90 and 98 percent, between 50 and 95 percent, between 60 and 95 percent, between 70 and 95 percent, between 80 and 95 percent, between 90 and 95 percent by weight of +crosslinker. In some embodiments, the crosslinker is a polar meth(acrylate).

In some embodiments, wherein the curable resin comprises a (meth)acrylate resin, a polyurethane precursor, an epoxy precursor (epoxide and hardener), a polyurea precursor, a cyanoacrylate resin, a polyester (meth)acrylate resin, a polyurethane (meth)acrylate resin, and combinations thereof. In some preferred embodiments the curable resin comprises a (meth)acrylate resin.

### Liner

In some embodiments, the curable resin is contacted with a liner before curing. A variety of materials are suitable for use as the liner, including both flexible materials and materials that are more rigid. Due to their ability to facilitate separation of the coating from the substrate, flexible materials may be preferred. The liner may include, for example, a polymeric film, a primed polymeric film, a metal foil, a cloth (e.g., a textile), a paper, a vulcanized fiber, a nonwoven material and treated versions thereof, and combinations thereof. In some embodiments, the liner is non-porous.

In some embodiments, for example, where the curable resin is designed to be polymerized, i.e., cured, by actinic radiation, or when greater flexibility is desired, the liner may be a polymeric film or treated polymeric film. Examples of such films include, but are not limited to, polyester film (e.g., polyethylene terephthalate film, polybutylene terephthalate film, polybutylene succinate film, polylactic acid film), co-polyester film, polyimide film, poly amide film, polyurethane film, polycarbonate film, polyvinyl chloride film, polyvinyl alcohol film, polypropylene film (e.g., biaxially oriented polypropylene), polyethylene film, poly(methyl methacrylate) film, and the like, In some embodiments, the film layer may be biodegradable film, e.g. polybutylene succinate film, polylactic add film. In some embodiments laminates of different polymer films may be used to form the liner. In embodiments wherein curable resin is designed to be polymerized, i.e. cured, by actinic radiation, the liner may allow for sufficient transmission of the actinic radiation to enable polymerization. In some embodiments, the liner has a percent transmission of at least 50 percent, at least 60 percent, at least 70 percent, at least 80 percent, at least 90 percent or at least 95 percent over at least a portion of the UV/Visible light spectrum. In some embodiments, the liner has a percent transmission of at least 50 percent, at least 60 percent, at least 70 percent, at least 80 percent, at least 90 percent or at least 95 percent over at least a portion of the visible light spectrum (about 400 to 700 nm). The percent transmission may be measured by conventional techniques and equipment, such as using a HAZEGARD PLUS haze meter from BYK-Gardner Inc., Silver Springs, Maryland, to measure the percent transmission of a film layer having an average thickness of from 1 to 100 micrometers. In some embodiments, the thickness of the film layer may be 1 to 1,000 micrometers, 1 to 500 micrometers, 1 to 200 micrometers, or 1 to 100 micrometers.

In some embodiments, the liner may include an antistatic material or the liner may include an antistatic coating on one or both of its major stufaces. The antistatic material and/or coating may include, for example, poly(3,4-ethylenedioxythiophene) polystyrene sulfonate (“PEDOT:PSS”) and trimetlwlacryloxyethyl ammonium bis(trifluoromethyl)sulfonimide.

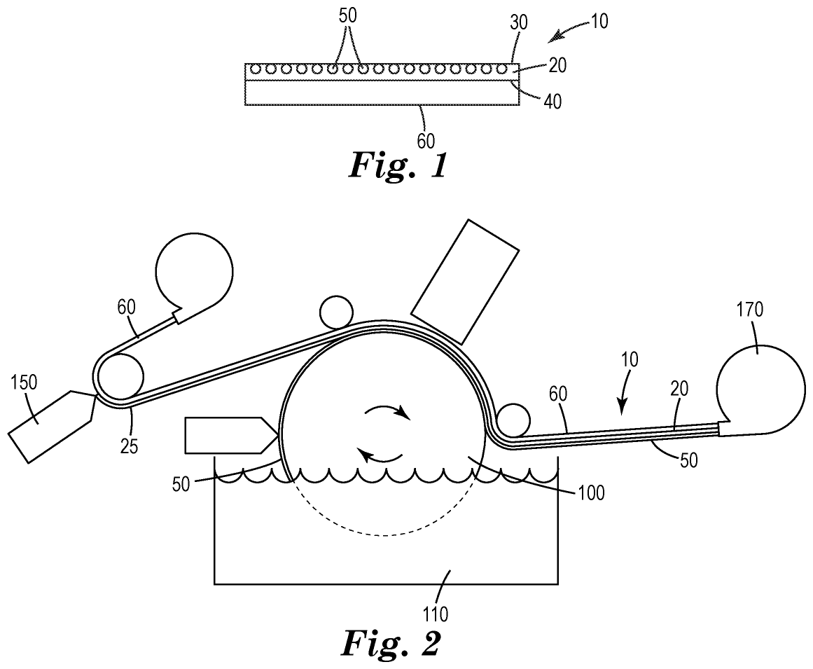

FIG. 1 shows a cross-sectional view of a laminate 10 including a coating 20 prepared according to some embodiments of methods of the present disclosure. As shown in FIG. 1, coating 20 has a first coating surface 30, an opposing second coating surface 40, a nanoparticle layer 50 disposed on first coating surface 30, and a liner 60 in contact with the second coating surface 40.

### Photoinitiator

In some embodiments, the curable resin further comprises 0.1 wt. % to 10 wt. % of a photoinitiator. Photinitiators, may be added to the curable resin to facilitate polymerization of the curable resin. The photoinitators are typically designed to be activated by the exposure to actinic radiation. Photoinitiators include, but are not limited to, those available under the trade designations “IRGACURE” and “DAROCUR” from BASF Corp, Florham Park, New Jersey, and include 1-hydroxy cyclohexyl phenyl ketone (trade designation “IRGACURE 184”), 2,2-dimethoxy-1,2-diphenyletion-1-one (trade designation “IRGACURE 651”), Bis(2,4,6-trimethylberizoyl)phenylphosphineoxide (trade designation “IRGACURE 819”), 1-[4-(2-hydroxyethoxy)phenyl]-2-hydroxy-2-methyl-1-propane-1-one (trade designation “IRGACURE 2959”), 2-benzyl-2-dimethylamino-1-(4-morpholinophenyl)butarione (trade designation “IRGACURE 369”), 2-methyl-1-4-(methylthio)phenyil-2-morpholinopropan-1-one (trade designation “IRGACURE 907”), and 2-hydroxy-2-methyl-1-phenyl protean-1-one (trade designation “DAROCUR 1173”),

### Other Additives

Other additives may optionally be included in the curable resin and, subsequently, the coating. Additives include, but are not limited to nanoparticles dispersed throughout the curable resin, pigments, surfactants, solvents, wetting aids, slip agents, leveling agents, tackifiers, toughening agents, reinforcing agents, fire retardants, antioxidants, antistatic agents (e.g., trimethylacryloxyethyl ammonium bis(trifluoromethyl)sulfonimide), stabilizers, and combinations thereof. The additives are added in amounts sufficient to obtain the desired end properties. In some embodiments, the amount of additive in the curable resin is from 0.1 wt. % to 60 wt%, 0.1 wt. % to 20 wt. %, or 0.1 wt. % to 10 wt. %.

### Hardcoat

A hardcoat may be prepared by the methods known to those of ordinary skill in the relevant arts and using the materials described above. The methods disclosed above can be scaled for roll-to-roll processing by one of ordinary skill in the relevant arts. For example, referring to FIG. 2, a drum with an oxide layer coating 100 may be rotated such that the oxide layer coating dips in and out of a nanoparticle slurry bath 110, resulting in a nanoparticle layer 50 adsorbed to drum 100. In between rotations, the required curable resin 25 (e.g., dispensed at coat head 150), lamination, curing (e.g., with a UV light source 160) and peeling steps may all take place, resulting in a laminate 10 that includes coating 20, nanoparticle layer 50, and liner 60, which can be wound up (e.g., onto a product winder 170) or optionally undergo further processing steps.

In preferred embodiments, hardcoats prepared according to methods of the present disclosure exhibit a delta haze less than 25, less than 10, less than 5, or less than 4 according to ASTM D1044-13.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 1
Materials

| Abbreviation | Description and Source |
|---|---|
| SR351H | Trimethylolpropane triacrylate available from Sartomer, Exton, |
| | Pennsylvania, as SR351H |
| SR9035 | Ethoxylated (15) trimethylolpropane triacrylate available from |
| | Sartomer as SR9035 |
| SR349 | Ethoxylated (3) bisphenol A diacrylate available from Sartomer as |
| | SR349 |
| SR9038 | Ethoxylated (30) bisphenol A diacrylate available from Sartomer as |
| | SR9038 |
| IRG819 | Bis (2,4,6-trimethylbenzoyl)-phenylphosphine oxide available from |
| | BASF Corporation, Florham Park, New Jersey, as IRGACURE 819 |
| D9228 | Colloidal silica-based slurry available from Cabot Micro Electronics |
| | Corporation, Aurora, Illinois, as IDIEL D9228. |
| PET1 | 2 mil (51 micron) polyethylene terephthalate film available from 3M |
| | Company, St. Paul, Minnesota, as SCOTCHPAK POLYESTER |
| | FILM |
| SR238B | 1,6 hexanediol diacrylate available from Sartomer as SR238B |
| SR295 | Pentaerythritol tetraacrylate available from Sartomer as SR295 |
| IRG184 | 1-hydroxycyclohexyl phenyl ketone available from BASF |
| | Corporation as IRGACURE 184 |
| IRGTPO | 2,4,6-trimethylbenzoyl-diphenyl phosphine oxide available from |
| | BASF Corporation as IRGACURE TPO |
| NBYK3650 | Nanoparticle dispersion of surface-treated silica, 20 nm particle size, |
| | available from BYK USA Incorporated, Wallingford, Connecticut, as |
| | NANOBYK-3650 |
| UV50 | Polyester-based release liner available from CPFilms Incorporated, |
| | Fieldale, Virginia, as UV50 |
| NALCO1056 | Colloidal nanoparticle dispersion of aluminum coated silica, 20 nm |
| | particle size, available from Nalco Chemical Company, Naperville, |
| | Illinois, as NALCO 1056 |
| HFPO-UA | Prepared as described in U.S. Pat. No. 7,722,955, product RP-2 |
| CN9039 | Hexafunctional urethane acrylate oligomer available from Sartomer |
| | as CN9039 |
| CN991 | Difunctional urethane acrylate oligomer available from Sartomer as |
| | CN991 |
| ESACURE ONE | Difunctional alpha hydroxy ketone available from IGM Resins, |
| | Charlotte, North Carolina, as ESACURE ONE |
| MEK | Methyl ethyl ketone available from Aldrich Chemical Company, |
| | Milwaukee, Wisconsin |
| PM | 1-methoxy-2-propanol available from Aldrich Chemical Company |
| PHOTOMER 6010 | Aliphatic urethane acrylate oligomer available from IGM Resins as |
| | PHOTOMER 6010 |
| SR602 | Ethoxylated (10) bisphenol A diacrylate available from Sartomer as |
| | SR602 |
| SR601 | Ethoxylated (4) bisphenol A diacrylate available from Sartomer as |
| | SR601 |
| SR339 | 2-phenoxyethyl acrylate available from Sartomer as SR339 |
| IRG1173 | 2-hydroxy-2-methyl-1-phenylpropane available from BASF |
| | Corporation as IRGACURE 1173 |
| IRG1035 | Thiodiethylene bis[3-[3,5-di-tert-butyl-4-hydroxyphenyl]propionate] |
| | available from BASF Corporation as IRGANOX 1035 |
| Silicon wafer | 8-inch diameter silicon wafers, 15,000 Å thick low particle PE-TEOS |
| | (Plasma Enhanced Tetra Ethyl Orthosilicate) film deposited on 200 |
| | mm Prime Silicon (P doped), item 2PET-0033-A, available from |
| | Advantiv Technologies, Inc., Freemont, CA |

### Examples 1-4: Direct Silicon Wafer Coating with UV LED Light Cure

In these examples, a coating solution was applied directly to a silicon wafer, as opposed to some later examples in which the solution was applied to the PET1 film first.

TABLE 2
UV-Curable Coating Solutions

| Preparatory | | Wt. % UV- | Wt. % |
|---|---|---|---|
| Examples | UV-Curable Resin | Curable Resin | IRG819 |
| PE1 | SR351H | 98 | 2 |
| PE2 | SR9035 | 98 | 2 |
| PE3 | SR349 | 98 | 2 |
| PE4 | SR9038 | 98 | 2 |

UV-curable acrylate functional coating solutions were prepared by dissolving IRGACURE 819 photo-initiator (2 wt. %) into various UV resins (98 wt. %) as supplied from the manufacturer, according to the preparatory examples PE1-PE4 in Table 2. For Examples 1-4, the coatings were PE1-PE4, respectively. A nanoparticle dispersion was prepared by diluting D9228 in a 6.5:1 volume ratio with deionized water (6.5 parts water, 1-part D9228). The nanoparticle dispersion was stirred with moderate agitation on a magnetic stir plate. A clean as-received silicon wafer was cut into a 1 in×1 in (2.5 cm×2.5 cm) coupon. The silicon wafer coupon was immersed in the nanoparticle dispersion for one minute with stirring to deposit nanoparticles onto the surface of the silicon wafer. The D9228 nanoparticle-coated silicon wafer was removed from the dispersion and rinsed with deionized water and dried with an air gun or by allowing the sample to sit at room temperature until dry. One to two drops of a UV-curable coating solution (Table 2) was deposited onto the surface of the silicon wafer with a pipette. A 1.5 in×1.5 in (3.8 cm×3.8 cm) piece of PET1 film was laid upon the deposited coating solution to form a wafer/nanoparticles/coating/film laminate. The laminate was placed under a UV LED radiation source, with the PET1 film being the topmost layer. The UV LED source was a CLEARSTONE TECH CF1000 unit equipped with a 391 nm UV LED bulb with the output power set to 100%. The working distance between the laminate and the UV LED was 2.75 inches (6.985 cm). The laminate was exposed to UV LED radiation for 20 seconds. The PET1 film and the cured coating with captured nanoparticles were peeled as a unit from the surface of the silicon wafer. SEM analysis revealed that the nanoparticles removed from the surface of the silicon wafer became concentrated at the surface of the cured coating that had been adjacent to the wafer.

### Example 5: Direct Silicon Wafer Coating with Medium-Pressure Mercury UV Light Cure

TABLE 3
UV-Curable Coating Solutions

| Preparatory | Wt. % | Wt. % | Wt. % | Wt. % |
|---|---|---|---|---|
| Example | SR238B | SR295 | IRG184 | IRGTPO |
| PE5 | 49 | 49 | 0.8 | 1.2 |

UV-curable coating solution PE5 was prepared by dissolving a photo-initiator blend (40/60 blend of IRG184 and IRGTPO; 2 wt. %) into a UV-curable resin blend (50/50 blend of SR238B and SR295; 98 wt. %) as supplied from the manufacture, according to Table 3. A nanoparticle dispersion was prepared by diluting D9228 in a 6.5:1 volume ratio with deionized water (6.5 parts water, 1-part D9228). The nanoparticle dispersion was stirred with moderate agitation on a magnetic stir plate. A clean silicon wafer, used as received, was cut into a 1 in×1 in (2.5 cm×2.5 cm). The silicon wafer coupon was immersed in the nanoparticle dispersion for one minute with stirring to deposit nanoparticles onto the surface of the silicon wafer. The nanoparticle-coated silicon wafer was removed from the dispersion and rinsed with deionized water and dried upon standing or with an air gun, as described above. One to two drops of the UV-curable coating solution (Table 3) was deposited onto the surface of the silicon wafer with a pipette. A 1.5 in×3 in (3.8 cm×7.6 cm) piece of PET1 film was laid upon the deposited coating solution to form a wafer/nanoparticles/coating/film laminate. The laminate was placed under a medium pressure mercury D bulb radiation source, with the PET1 film being the topmost layer. The UV processor with the medium pressure mercury D bulb radiation source was a HERAEUS FUSION UV SYSTEMS INC. unit equipped with a LIGHT HAMMER 6 Model LH6BPS 500 W/in (200 W/cm) power source with the output power set to 100%. The laminate was carried through the UV processor by a conveyor belt system at a speed of 40 feet/minute (12.192 m/minute). The PET1 film and the cured coating with captured nanoparticles were peeled as a unit from the surface of the silicon wafer. The film and coating unit was further exposed to a second UV radiation source with a subsequent pass through the same UV processor as outlined above with the coating surface upwards and facing the second UV source. A medium pressure mercury vapor bulb (H bulb) was used at 100% power setting, and the process area was purged with nitrogen gas. The film/coating unit was carried through the UV processor by a conveyor belt system at a speed of 60 feet/minute (18.288 m/minute). SEM analysis revealed that the nanoparticles that were removed from the surface of the silicon wafer became concentrated at the surface of the cured coating that had been adjacent to the wafer.

### Example 6 and Comparative Examples 1-2: Indirect Silicon Wafer Coating with Medium-Pressure Mercury UV Light Cure

In these examples, the PET1 film was coated with solution rather than the nanoparticle/silicon wafer, then the uncured coating was brought into contact with nanoparticles on Si wafer.

TABLE 4
UV-Curable Coating Solutions

| Preparatory | Wt. % | Wt. % | Wt. % | Wt. % | Wt. % | Formula |
|---|---|---|---|---|---|---|
| Example | SR238B | SR295 | IRG184 | IRGTPO | NBYK3650 | % Solids |
| PE6 | 49 | 49 | 0.8 | 1.2 | 0 | 100% |
| PE7 | 20 | 20 | 0.5 | 0.7 | 58.8 | 58.8% |

Coating solutions were prepared according to the table above. For PE6, photo-initiators were dissolved into a 50/50 blend of SR238B and SR295, each resin as supplied from manufacturer. NANOBYK-3650 is supplied at 30% solids. For PE7, the wt. % of NANOBYK-3650 in the dry coating is 30%. The UV-curable coating solutions from the table above were coated onto PET1 film. For Example 6 and Comparative Example 1, PE6 was coated with Mayer rod #5 (R D Specialties, Webster, New York). For Comparative Example 2, PE7 was coated with Mayer rod #9. Each of the Mayer rod coatings were approximately 5 in×7 in (12.7 cm×17.8 cm); a size sufficient for Taber abrasion testing. PET1 film with PE7 coated thereupon was dried for 45 seconds at 80° C. Meanwhile, a nanoparticle dispersion was prepared by diluting D9228 in a 6.5:1 volume ratio with deionized water (6.5 parts water, 1-part D9228). The nanoparticle dispersion was set to moderate agitation on a magnetic stir plate. A clean silicon wafer [detail on silicon wafer above] was cut in half. The silicon wafer half was immersed in the nanoparticle dispersion while stirring for 1 min. During this process nanoparticles deposited onto to the surface of the silicon wafer. The silicon wafer was then removed from the dispersion and rinsed with deionized water and dried.

TABLE 5
Preparation and Results of Example 6 and Comparative Examples 1, 2

| | Coating | Mayer | |
|---|---|---|---|
| Example | Solution | Rod | Nanoparticle Disposition |
| EX6 | PE6 | 5 | Nanoparticles stripped from oxide surface, |
| | | | thus concentrated at coating surface |
| CE1 | PE6 | 5 | No nanoparticles present |
| CE2 | PE7 | 9 | 30 wt. % NANOBYK-3650 nanoparticles |
| | | | throughout the coating’s bulk |

For Example 6, a PET1 film with PE6 coatedthereupon was brought into contact with the nanoparticle-ladened silicon wafer described above. This laminate stack comprising wafer, nanoparticles, coating, and film was then exposed to a medium pressure mercury D bulb radiation source, the PET1 film being the topmost layer. The UV source was a HERAEUS FUSION UV SYSTEMS INC. unit equipped with a LIGHT HAMMER 6 Model LH6BPS 500 W/in (200 W/cm) power source. The output power was set to 100%. The laminate was carried through the UV processor by a conveyor belt system at a speed of 40 ft/min (12.192 m/min). Next the PET1 film with the cured coating and captured nanoparticles was peeled from the surface of the silicon wafer. The film and coating were once again exposed to UV radiation. During this subsequent pass through the same UV processor as outlined above, the coating surface was upwards and facing the UV source. An H bulb was used at 100% power setting, and the process area was purged with nitrogen gas. The film/coating was carried through the UV processor by a conveyor belt system at a speed of 60 ft/min (18.288 m/min).

For Comparative Example 1, another PET1 film with PE6 coated thereupon was brought into contact with release liner UV50. This laminate stack comprising film, coating, and release liner was then exposed to a medium pressure mercury D bulb radiation source, the PET1 film being the topmost layer. The UV source was a HERAEUS FUSION UV SYSTEMS INC. unit equipped with a LIGHT HAMMER 6 Model LH6BPS 500 W/in (200 W/cm) power source. The output power was set to 100%. The laminate was carried through the UV processor by a conveyor belt system at a speed of 40 ft/min (12.192 m/min). Next the PET1 film with the cured coating was peeled from the surface of the silicon wafer. The film and coating were once again exposed to UV radiation. During this subsequent pass through the same UV processor as outlined above, the coating surface was upwards and facing the UV source. An H bulb was used at 100% power setting, and the process area was purged with nitrogen gas. The film/coating was carried through the UV processor by a conveyor belt system at a speed of 60 ft/min (18.288 m/min).

For Comparative Example 2, a final PET1 film with PE7 coated thereupon was brought into contact with release liner UV50. Note from Table 4 that coating PE7 has NBYK3650 nanoparticles dispersed in it. This laminate stack comprising film, coating, bulk nanoparticles and release liner was then exposed to a medium pressure mercury D bulb radiation source, the PET1 film being the topmost layer. The UV source was a HERAEUS FUSION UV SYSTEMS INC. unit equipped with a LIGHT HAMMER 6 Model LH6BPS 500 W/in (200 W/cm) power source. The output power was set to 100%. The laminate was carried through the UV processor by a conveyor belt system at a speed of 40 ft/min (12.192 m/min). Next the PET1 film with the cured coating and bulk nanoparticles was peeled from the surface of the silicon wafer. The film and coating were once again exposed to UV radiation. During this subsequent pass through the same UV processor as outlined above, the coating surface was upwards and facing the UV source. An H bulb was used at 100% power setting, and the process area was purged with nitrogen gas. The film/coating was carried through the UV processor by a conveyor belt system at a speed of 60 ft/min (18.288 m/min). Results of SEM analysis of the samples are shown in Table 5.

### Hardcoat Testing

TABLE 6
Hardcoat Testing

| | Average. | Average | Average. | Average | | |
|---|---|---|---|---|---|---|
| | Initial | Initial | Final | Final | Delta | Delta |
| Example | Transmission | Haze | Transmission | Haze | Transmission | Haze |
| EX6 | 92.4 | 0.33 | 91.6 | 3.79 | −0.80 | 3.46 |
| CE1 | 92.2 | 1.355 | 90.8 | 7.305 | −1.4 | 5.95 |
| CE2 | 92.3 | 1.225 | 90.9 | 5.855 | −1.4 | 4.63 |

The initial transmission and haze of Example 6, CE1, and CE2 were measured with a BYK HAZE GARD I instrument (BYK Instruments, Geretsried, Germany). The results are shown in the table above. The examples were tested for abrasion resistance according to ASTM D1044-13. Two specimens for each condition were tested and the results averaged. CS-10F abrasive wheels, 100 cycles, 500 gram load, 60 cycles/min. The post-abrasion (final) haze and transmission were measured on the same instrument.

### Examples 7 and 8: Pre-Masks for Reactive Ion Etching

TABLE 7
Composition of Preparatory Example 8 for Example
7 (Amounts in this table are parts by weight.)

| | PHOTO- | | | | | | | |
|---|---|---|---|---|---|---|---|---|
| | MER | | | | | | | |
| ID No. | 6010 | SR602 | SR601 | SR351H | SR339 | IRG1173 | IRGTPO | IRG1035 |
| PE8 | 60 | 20 | 4 | 8 | 8 | 0.35 | 0.1 | 0.2 |

TABLE 8
Composition of Preparatory Example 9 for Example
8 (Amounts in this table are parts by weight.)

| | | | | ESACURE | | |
|---|---|---|---|---|---|---|
| ID No. | HFPO-UA | CN9039 | CN991 | ONE | MEK | PM |
| PE9 | 4.4 | 24 | 10 | 0.36 | 45.93 | 15.31 |

HFPO-UA was prepared as described in U.S. Pat. No. 7,722,955 (Audenaert, et al.), there identified as RP-2, with the exception that HFPO-UA was prepared at 60% solids using acetone in a 50° C. bath rather than at 50% solids in MEK using an 80° C. bath.

Coating solutions were prepared according to Tables 7 and 8 above. PE8 was diluted to 37% solids with MEK, making the % solids of each PE8 and PE9 solution to be 37%. PE8 and PE9 were coated onto PET1 film with Mayer rod #7 (R D Specialties, Webster, New York). Each of the Mayer rod coatings were approximately 5 in×7 in (12.7 cm×17.8 cm). Both coatings were dried for 90 seconds at 80° C. (It should be noted that, after drying, both formulations have very high viscosity and resistance to flow. PE8 is 9160 cP at 25° C.). Meanwhile, a nanoparticle dispersion was prepared by diluting D9228 in a 6.5:1 volume ratio with deionized water (6.5 parts water, 1-part D9228). The nanoparticle dispersion was set to moderate agitation on a magnetic stir plate. Two clean silicon wafer halves [detail on silicon wafer above] were immersed in the nanoparticle dispersion while stirring for 1 min. During this process nanoparticles deposited onto to the surface of the silicon wafers. The silicon wafers were then removed from the dispersion and rinsed with deionized water and dried.

Two separate PET1 films with PE8 and PE9 coated thereupon were brought into contact with the nanoparticle-laden silicon wafers described above. These laminate stacks comprising wafer, nanoparticles, coating, and film were then exposed to a medium pressure mercury D bulb radiation source, the PET1 film being the topmost layer. The UV source was a HERAEUS FUSION UV SYSTEMS INC. unit equipped with a LIGHT HAMMER 6 Model LH6BPS 500 W/in (200 W/cm) power source. The output power was set to 100%. The laminates were carried through the UV processor by a conveyor belt system at a speed of 40 ft/min (12.192 m/min). Next the PET1 films with the cured coatings and captured nanoparticles were peeled from the surface of the silicon wafers. The films and coatings were once again exposed to UV radiation. During this subsequent pass through the same UV processor as outlined above, the coating surface was upwards and facing the UV source. An H bulb was used at 100% power setting, and the process area was purged with nitrogen gas. The film/coating was carried through the UV processor by a conveyor belt system at a speed of 60 ft/min (18.288 m/min).

The films and coatings underwent a reactive ion etching process. Following the lamination process, reactive ion etching was carried out on the films in a home-built parallel plate capacitively coupled plasma reactor. The chamber has a central cylindrical powered electrode with a surface area of 18.3 ft². After placing the coated film on the powered electrode, the reactor chamber was pumped down to a base pressure of less than 1.3 Pa (1 mTorr). O₂ gas was flowed into the chamber at a rate of 100 SCCM. 13.56 MHz RF power was subsequently coupled into the reactor with an applied power of 7500 W. The film was then carried through the reaction zone at a rate of 2.5 ft/min, to achieve an exposure time of 120 s. At the end of this treatment time, the RF power and the gas supply were stopped, and the chamber was returned to atmospheric pressure. Additional information regarding materials and processes for continuous reactive ion etching through a nanostructured mask and further details around the reactor used can be found in U.S. Pat. No. 8,460,568 (David, et al.). Subsequent inspection by SEM analysis of etched samples EX7 and EX8 showed that the nanoparticles had acted as pre-masks for the reactive ion etching process, with each particle located atop a stalk of unetched coating material that was shadowed by the nanoparticle.

1. A method of embedding nanoparticles in a coating, the method comprising:
contacting a first surface of a nanoparticle layer with a curable resin; and
curing the curable resin to form a coating having a first coating surface and an opposing second coating surface;
wherein the nanoparticles are concentrated at the first coating surface.

2. The method of claim 1, wherein the nanoparticle layer is a monolayer.

3. The method of claim 2, wherein the monolayer is a continuous layer.

4. The method of claim 1, wherein the nanoparticle layer comprises silica, alumina, ceria, diamond, titanium dioxide, zinc oxide, tungsten oxide, zirconia, and combinations thereof.

5. The method of claim 1, wherein the nanoparticle layer is coated on a substrate before it is contacted with the curable resin.

6. The method of claim 5, wherein the substrate comprises a silicon, a glass, a metal, a metal oxide, a polymeric film, and combinations thereof.

7. The method of claim 5, further comprising separating the coating from the substrate.

8. The method of claim 1, wherein the curable resin is contacted with a liner before curing.

9. The method of claim 8, wherein the liner is a polymeric film.

10. The method of claim 1, wherein the curable resin comprises a (meth)acrylate resin, a polyurethane precursor, an epoxy precursor, a polyurea precursor, a cyanoacrylate resin, a polyester (meth)acrylate resin, a polyurethane (meth)acrylate resin, and combinations thereof.

11. The method of claim 10, wherein the curable resin comprises a (meth)acrylate resin.

12. The method of claim 10, wherein the (meth)acrylate resin comprises a (meth)acrylate resin wherein at least one (meth)acrylate component has a functionality of two or higher.

13. The method of claim 1, wherein the curable resin further comprises a photoinitiator.

14. The method of claim 13, wherein the curable resin comprises 0.1 wt. % to 10 wt. % of the photoinitiator.

15. The method of claim 1, wherein curing comprises exposing the curable resin to actinic radiation.

16. The method of claim 1, wherein the curable resin further comprises 0.1 wt. % to 60 wt. %, 0.1 wt. % to 20 wt. %, or 0.1 wt. % to 10 wt of a nanoparticle dispersed throughout the curable resin bulk, a pigment, an antioxidant, a surfactant, a solvent, a wetting aid, a slip agent, a leveling agent, and combinations thereof.

17. A hardcoat prepared by the method of claim 1.

18. The hardcoat of claim 17, wherein the hardcoat has a delta haze less than 25, less than 10, or less than 5 according to ASTM D1044-13.
